(19) United States
(12) Patent Application Publication
(10) Pub. No.: US 2024/0278392 A1
(43) Pub. Date: Aug. 22, 2024

(54) RATCHET TOOL

(71) Applicant: Nanjing Chervon Industry Co., Ltd., Nanjing (CN)

(72) Inventors: Hengyong Hu, Nanjing (CN); Chengyu Zheng, Nanjing (CN); Shubin Tong, Nanjing (CN)

(21) Appl. No.: 18/537,346

(22) Filed: Dec. 12, 2023

(30) Foreign Application Priority Data
Feb. 22, 2023 (CN) 202310146744.3
Feb. 22, 2023 (CN) 202320279744.6
Apr. 7, 2023 (CN) 202310365400.1

(51) Int. Cl. B25B 21/00

(52) U.S. Cl. CPC B25B 21/004

(57) ABSTRACT

A ratchet tool includes a drive shaft rotating about a first axis; a ratcheting mechanism driven by the drive shaft; a trigger switch, where a motor corresponds to different output rotational speeds according to different trigger strokes of the trigger switch; a human-machine interaction assembly coupled to a controller; and a controller configured to adjust, according to a setting of the human-machine interaction assembly, an output rotational speed or a range of output rotational speeds of the motor when the trigger switch has a maximum trigger stroke.

### RELATED APPLICATION INFORMATION

This application claims the benefit under 35 U.S.C. § 119(a) of Chinese Patent Application No. 202320279744.6, filed on Feb. 22, 2023, Chinese Patent Application No. 202310146744.3, filed on Feb. 22, 2023, and Chinese Patent Application No. 202310365400.1, filed on Apr. 7, 2023, which applications are incorporated herein by reference in their entireties.

### TECHNICAL FIELD

The present application relates to the technical field of power tools and, in particular, to a ratchet tool.

### BACKGROUND

A ratchet tool is used for applying torque to a fastener to tighten or loosen the fastener. In the ratchet tool, a ratchet gear and a pawl mate with each other so that a user can complete the transmission of rotational torque simply by a small swing of a handle. An electric ratchet tool uses a motor to drive a ratcheting mechanism, so as to tighten or loosen the fastener. Generally speaking, the electric ratchet tool typically drives the motor to rotate in only one direction.

This part provides background information related to the present application, which is not necessarily the existing art.

### SUMMARY

A ratchet tool includes a housing formed with or connected to a grip; a motor including a drive shaft rotating about a first axis; a ratcheting mechanism driven by the drive shaft, where the ratcheting mechanism includes an output shaft rotating about an output axis and a pawl, and a direction of rotation of the output shaft is controlled by a position of the pawl; where when the pawl is at a first position, the output shaft rotates in a first direction; and when the pawl is at a second position, the output shaft moves in a second direction; a trigger switch, where the motor corresponds to different output rotational speeds according to different trigger strokes of the trigger switch; a human-machine interaction assembly configured to be operated and output information; and a controller for controlling the motor; where the human-machine interaction assembly is coupled to the controller; and the controller is configured to adjust, according to a setting of the human-machine interaction assembly, an output rotational speed or a range of output rotational speeds of the motor when the trigger switch has a maximum trigger stroke.

In some examples, the human-machine interaction assembly includes an operating element and a second controller, where the second controller is coupled to the controller.

In some examples, the second controller presets parameters of at least two gear modes, and the operating element is operated to select one of the at least two gear modes, where each of the at least two gear modes corresponds to a parameter of one output rotational speed or one range of output rotational speeds of the motor when the trigger switch has the maximum trigger stroke.

In some examples, the controller controls, according to a signal of a parameter outputted from the second controller, the output rotational speed of the motor when the trigger switch has the maximum trigger stroke.

In some examples, the ratchet tool further includes at least a first mode and a second mode, where the human-machine interaction assembly is further configured to switch a mode of the ratchet tool.

In some examples, when the ratchet tool is in the first mode, the controller is configured to control, according to a load parameter of the output shaft, the motor to repeatedly change a direction of rotation of the drive shaft.

In some examples, the ratchet tool further includes a detection mechanism for detecting the load parameter of the output shaft, where the load parameter of the output shaft includes at least one of a rotational speed-related parameter of the motor and a current-related parameter of the motor.

In some examples, the ratchet tool further includes a detection mechanism for detecting the load parameter of the output shaft, where the load parameter of the output shaft includes at least one of a rotational speed of the output shaft, an angle of rotation of the output shaft, and rotational acceleration of the output shaft.

In some examples, when the ratchet tool is in the second mode, the controller is configured to control the drive shaft of the motor to rotate in a set direction.

In some examples, the human-machine interaction assembly includes a control circuit board extending within a first plane, and the housing extends substantially along a direction of the first axis, where the control circuit board obliquely intersects the first axis.

In some examples, the angle between the first axis and the first plane on a side of the output shaft is less than or equal to 45°.

In some examples, the human-machine interaction assembly is disposed in front of or behind the grip.

A ratchet tool includes a housing formed with or connected to a grip for holding; a motor including a drive shaft rotating about a first axis; a ratcheting mechanism driven by the drive shaft, where the ratcheting mechanism includes an output shaft rotating about an output axis and a pawl, and a direction of rotation of the output shaft is controlled by a position of the pawl; wherein when the pawl is at a first position, the output shaft rotates in a first direction; and when the pawl is at a second position, the output shaft moves in a second direction; a controller for controlling the motor; and a human-machine interaction assembly coupled to the controller. The ratchet tool includes a selectable first mode and a selectable second mode, where when the ratchet tool is in the first mode, the controller controls an output state of the motor according to a load parameter of the output shaft; when the ratchet tool is in the second mode, the controller controls the output state of the motor according to input information of the human-machine interaction assembly; and the human-machine interaction assembly is configured to switch a mode of the ratchet tool and/or set the input information.

A ratchet tool includes a housing formed with or connected to a grip for holding; a motor including a drive shaft rotating about a first axis; a ratcheting mechanism driven by the drive shaft, where the ratcheting mechanism includes an output shaft rotating about an output axis and a pawl, and a direction of rotation of the output shaft is controlled by a position of the pawl; where when the pawl is at a first position, the output shaft rotates in a first direction; and when the pawl is at a second position, the output shaft moves in a second direction; a trigger switch, where the motor corresponds to different output rotational speeds according to different trigger strokes of the trigger switch; and a speed adjustment assembly configured to adjust an output rotational speed of the output shaft when the trigger switch has a maximum trigger stroke.

In some examples, a controller is further included, where the controller is configured to control, according to received input information, an output rotational speed of the motor when the trigger switch has the maximum trigger stroke.

In some examples, a human-machine interaction assembly is further included, where the human-machine interaction assembly is coupled to the controller and configured to be operated to set input information.

In some examples, the human-machine interaction assembly includes an operating element and a second controller, where the second controller is coupled to the controller.

In some examples, the second controller is configured to convert an instruction received by the operating element into corresponding input information and send a signal of the corresponding input information to the controller.

In some examples, the second controller presets at least two gear modes, and the operating element is operated to select one of the at least two gear modes, where each of the at least two gear modes is configured with respective input information.

In some examples, the ratchet tool further includes a transmission assembly for connecting the motor to the ratcheting mechanism, where the speed adjustment assembly is mechanically coupled to the transmission assembly to adjust a gear ratio of the transmission assembly.

### BRIEF DESCRIPTION OF THE DRAWINGS

FIG. 1 is a structural view of an example of the present application;

FIG. 2 is a structural view of an example of the present application from another perspective;

FIG. 3 is a structural view of a transmission mechanism and a ratcheting mechanism of the present application;

FIG. 4 is a cross-sectional view of a ratcheting mechanism;

FIG. 5 is a partial sectional view of FIG. 2;

FIG. 6 is a structural view of a human-machine interaction assembly in FIG. 2;

FIG. 7 is a partial structural view of FIG. 6 from another perspective;

FIG. 8 shows another example of the present application, where a human-machine interaction assembly is at a different position;

FIG. 9 is an exploded view of a transmission mechanism;

FIG. 10 is a circuit block diagram of an example of the present application;

FIG. 11 is another circuit block diagram of an example of the present application;

FIG. 12 is a structural view of a ratchet tool with a lighting mechanism according to another example of the present application;

FIG. 13 is a structural view of FIG. 12 from another perspective;

FIG. 14 is a partial sectional view of FIG. 13 taken along D-D;

FIG. 15 shows a lighting mechanism in a first manner according to an example;

FIG. 16A shows a lighting mechanism in a second manner according to example one;

FIG. 16B shows a lighting mechanism in a third manner according to example one;

FIG. 17 is a structural view of a ratchet tool with another type of lighting mechanism according to another example of the present application; and

FIG. 18 is a structural view of a ratchet tool with a third type of lighting mechanism according to another example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

To clearly illustrate technical solutions of the present application, an upper side, a lower side, a left side, a right side, a front side, and a rear side are defined in the drawings of the specification.

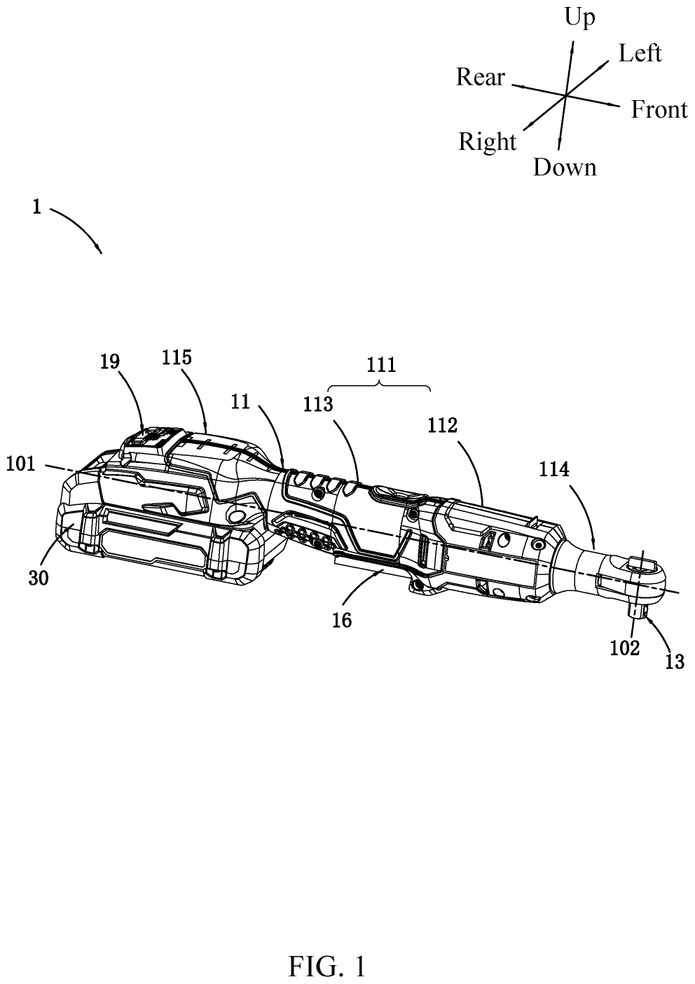

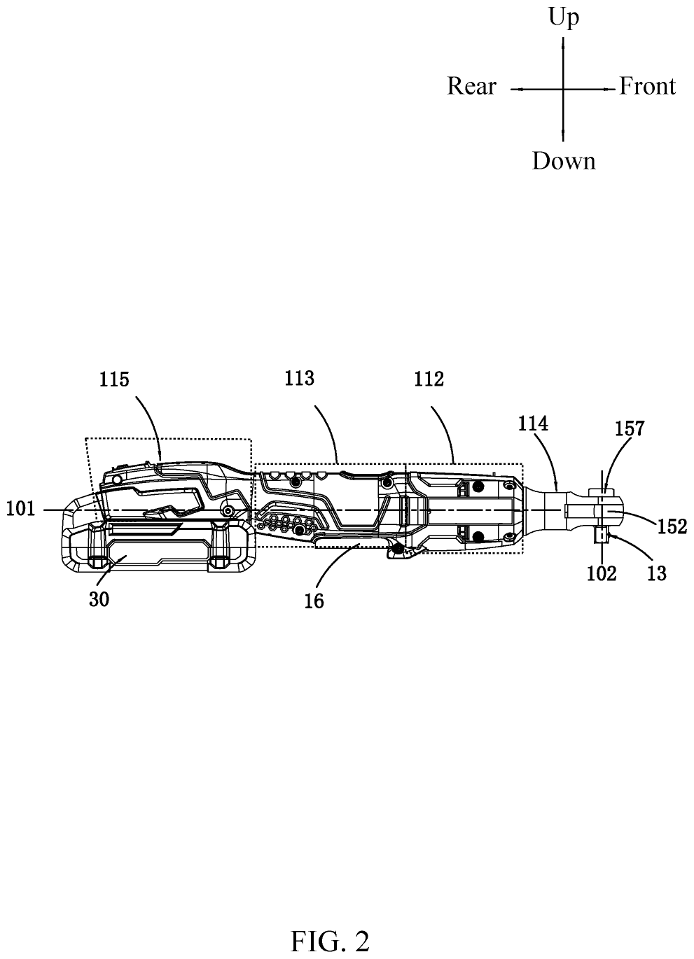

FIGS. 1 and 2 show a ratchet tool in an example of the present application. In this example, the ratchet tool is a ratchet wrench 1. In other alternative examples, the ratchet tool may be installed with different working accessories to implement other functions.

As shown in FIG. 1, the ratchet wrench 1 includes a power supply for supplying electrical energy to the ratchet wrench 1. In this example, the power supply is a direct current power supply 30. Optionally, the direct current power supply 30 is a battery pack, and the battery pack mates with a corresponding power supply circuit to supply power to the ratchet wrench 1. It is to be understood by those skilled in the art that the direct current power supply 30 is not limited to the battery pack and may be a built-in rechargeable battery or a standard battery. In other alternative examples, the ratchet wrench 1 may supply power to corresponding components in the ratchet wrench 1 through mains power or an alternating current power supply in conjunction with corresponding rectifier, filter, and voltage regulator circuits. For convenience of reference, the battery pack 30 is used instead of the direct current power supply in the following description, which is not to limit the present invention.

In some examples, the battery pack 30 may be a lithium battery pack, a solid-state battery pack, or a pouch battery pack. A nominal voltage of the battery pack 30 is higher than or equal to 4 V and lower than or equal to 80 V. Optionally, the nominal voltage of the battery pack 30 is higher than or equal to 10 V and lower than or equal to 48 V.

As shown in FIGS. 1 to 5, the ratchet wrench 1 includes a housing 11, a motor 12, a transmission mechanism 14, a ratcheting mechanism 15, and an output shaft 13. The housing 11 includes a main housing 111, a head housing 114 for accommodating at least part of the output shaft 13, and a power supply connecting portion 115 connected to the battery pack 30. The housing 11 extends substantially parallel to a first axis 101. It is to be interpreted that in an actual product, some modeling structures are provided on the housing to achieve a special shape, beauty, or comfortableness of the product so that the housing 11 is formed with or connected to some structures, but the overall extension tendency of the housing is parallel to the first axis 101, which is within the scope disclosed by that the housing 11 extends substantially parallel to the first axis 101 in the present application. In this example, the power supply connecting portion 115 is disposed on the rear side of the main housing 111, and the head housing 114 is disposed on the front side of the main housing 111. The main housing 111 is substantially tubular. The motor 12 and the transmission mechanism 14 are at least partially disposed in the main housing 111. The main housing 111 includes a grip 113 for holding and a motor housing 112. The grip 113 is closer to the power supply connecting portion 115. The motor housing 112 is closer to the head housing 114. The head housing 114 is secured around the outer circumference of an end of the main housing 111 through fasteners. The ratcheting mechanism 15 and the output shaft 13 are at least partially disposed in the head housing 114. In some alternative examples, an interference connection, a snap connection, a plug connection, a pin connection, and other manners may be used so long as the head housing 114 can be fastened to the main housing 111 and is convenient to detach and install, which are within the scope of the present invention.

The power supply connecting portion 115 is used for receiving the battery pack 30. Optionally, the battery pack 30 is connected to the power supply connecting portion 115 or at least partially disposed in the power supply connecting portion 115. The power supply connecting portion 115 includes a coupling portion 116 detachably connected to the battery pack 30.

The motor 12 includes a drive shaft 121 rotatable about a drive axis. In this example, the drive axis coincides with the first axis 101. In other alternative examples, the drive axis and the first axis 101 are parallel to each other but do not coincide. In other alternative examples, the drive axis and the first axis 101 are arranged at a certain angle. In this example, the motor 12 is specifically an electric motor, and the electric motor 12 is used instead of the motor in the subsequent description, which is not to limit the present invention.

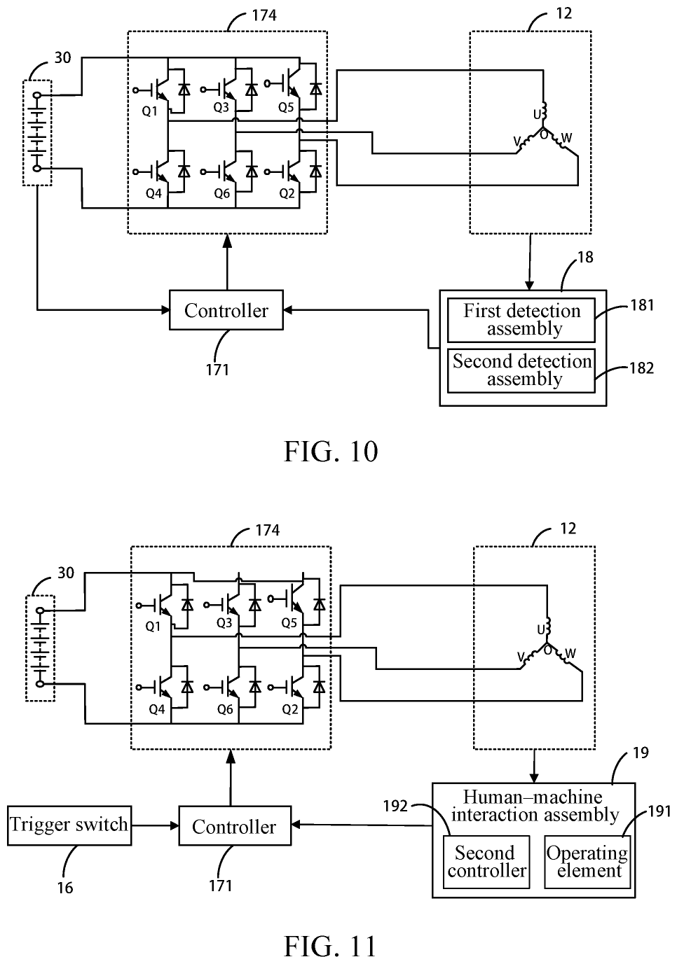

As shown in FIG. 10, the electric motor 12 includes stator windings and a rotor. The electric motor 12 is a three-phase brushless motor including the rotor with a permanent magnet and three-phase stator windings U, V, and W electronically commutated. In some examples, the three-phase stator windings U, V, and W adopt a star connection. In some other examples, the three-phase stator windings U, V, and W adopt a delta connection. However, it is to be understood that other types of brushless motors are also within the scope of the present disclosure. The brushless motor may include less than or more than three phases.

The ratchet wrench 1 further includes a trigger switch 16 installed on the grip 113. When holding the grip 113, a user can trigger a switch relatively conveniently, where the switch may be configured to be the trigger switch 16 for activating the ratchet wrench 1.

The output shaft 13 is used for receiving torque supplied by the electric motor 12 and output power. A clamping assembly or a receiving portion is disposed at the front end of the output shaft 13 and may clamp corresponding working accessories, such as a screwdriver, a drill bit, and a sleeve, when different functions are implemented. The output shaft 13 rotates about an output axis. In this example, the output axis is a second axis 102. The second axis 102 is orthogonal to the first axis 101. In some alternative examples, the second axis 102 intersects the first axis 101 at a certain angle.

The transmission mechanism 14 is disposed between the electric motor 12 and the output shaft 13 and used for transmitting power between the electric motor 12 and the output shaft 13. The transmission mechanism 14 includes a planetary transmission set for reduction, where the planetary transmission set converts an output rotational speed of the electric motor 12 at a certain gear ratio to achieve suitable torque. It is to be understood that this example is only a preferred solution of the present invention, and the transmission mechanism 14 is not limited to a planetary gear reduction mechanism and may be another reduction mechanism, such as a bevel gear reduction mechanism.

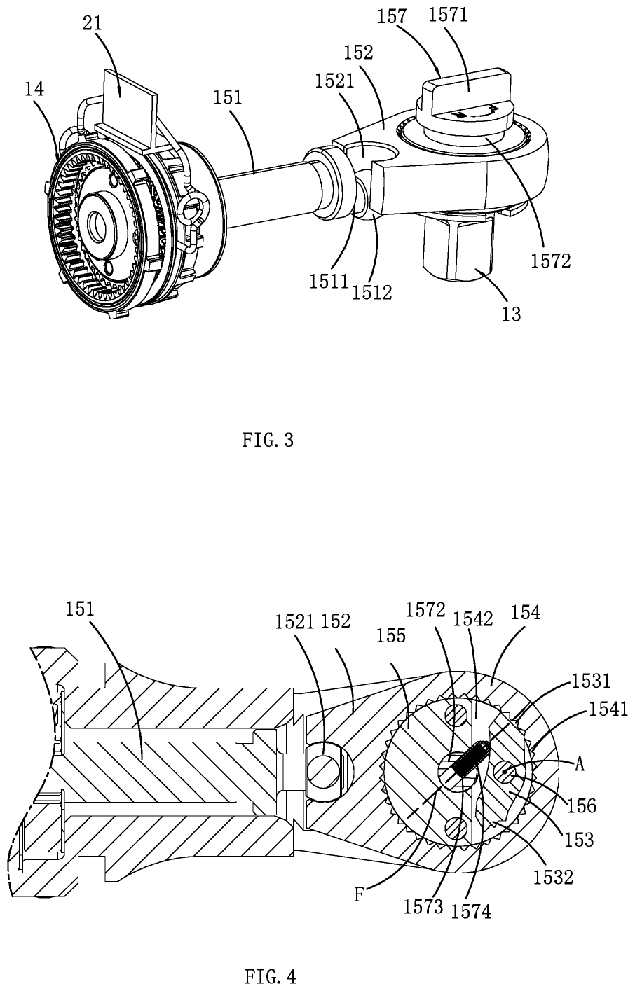

As shown in FIGS. 3 and 4, the ratcheting mechanism 15 includes an eccentric member 151, a swing member 152, a pawl 153, a ratchet gear 154, and an anvil 155. An end of the eccentric member 151 is connected to a planetary gear train in a non-rotatable manner, and the other end of the eccentric member 151 is provided with an eccentric portion 1511. The swing member 152 is pivotally connected to the head housing 114.

The eccentric portion 1511 is connected to the swing member 152 to convert a rotational motion of the drive shaft 121 about the first axis 101 into a reciprocating swing of the swing member 152 about the second axis 102. It is to be understood that the “reciprocating swing” is moving back and forth on two sides of a certain position. In this example, the “reciprocating swing about the second axis” may be understood as a reciprocating motion along a first direction (for example, clockwise) and a second direction (for example, counterclockwise), respectively, about the second axis 102. Optionally, the swing member 152 is provided with a recessed portion 1521 corresponding to the eccentric portion 1511 of the eccentric member 151, and a drive sleeve 1512 mating with the recessed portion 1521 is sleeved on the eccentric portion 1511. The drive sleeve 1512 rotates eccentrically about a central axis of the eccentric member 151, and during the eccentric rotation, the drive sleeve 1512 drives the swing member 152 to perform the reciprocating swing about the second axis 102 periodically.

The anvil 155 is used for pivotally supporting the swing member 152 in the head housing 114. The output shaft 13 is formed on or connected to the anvil 155. It is to be understood that the anvil 155 and the output shaft 13 may be integrally formed or separately formed as independent parts.

The swing member 152 is formed with or connected to the ratchet gear 154. In this example, the ratchet gear 154 and the swing member 152 are integrally formed. The ratchet gear 154 is provided with a central hole 1542 for receiving the anvil 155. The pawl 153 is connected to the anvil 155 through a first pin 156. The ratchet gear 154 is provided with ratchet teeth 1541 mating with the pawl 153. The pawl 153 includes a first set of teeth 1531 and a second set of teeth 1532 spaced from the first set of teeth 1531. The pawl 153 is rotatable about the first pin 156 so that the first set of teeth 1531 or the second set of teeth 1532 meshes with the ratchet teeth 1541, and the other set of teeth is spaced apart from the ratchet teeth 1541. As shown in FIG. 4, the first set of teeth 1531 meshes with the ratchet teeth 1541. In this case, when the ratchet gear 154 is driven by the swing member 152 to swing in a clockwise direction about the second axis 102 relative to the anvil 155, the ratchet teeth 1541 mesh with the first set of angled teeth 1531 on the pawl 153 so that the ratchet gear 154 drives the anvil 155 to rotate together clockwise about the second axis 102, that is, the output shaft 13 rotates in the first direction (clockwise). Due to the reciprocating swing of the ratchet gear 154, the ratchet gear 154 is then driven to swing in a counterclockwise direction about the second axis 102 relative to the anvil 155, the ratchet teeth 1541 slide past the pawl 153, and the pawl 153 stops rotating, that is, the anvil 155 stops rotating. Therefore, rotation in only one direction is transmitted from the ratchet gear 154 to the output shaft 13, and a direction of rotation of the output shaft 13 is controlled by the pawl 153.

To conveniently change the direction of rotation of the output shaft 13, the ratcheting mechanism 15 further includes a direction selector 157. The direction selector 157 includes a shaft portion 1572 and an operating portion 1571. In this example, the shaft portion 1572 extends into the anvil 155. The operating section 1571 is at least partially disposed on the outer side of the head housing 114 to be operated by the user. The direction selector 157 further includes a biasing assembly including a spring 1573 and a spring cap 1574. The spring 1573 and the spring cap 1574 are inserted into the shaft portion 1572 of the direction selector 157 to support the pawl 153 in biasing one set of teeth to abut against the ratchet teeth 1541. In this example, the direction selector 157 rotates about the second axis 102. In other examples, the direction selector 157 may rotate about another axis or be toggled or be electrically powered to change a position of the pawl 153.

When the direction selector 157 rotates about the second axis 102, the spring cap 1574 moves along the surface of the pawl 153 to rotate the pawl 153 about the pin. Optionally, when a line F of action of a biasing force of the spring cap 1574 and the spring 1573 moves beyond a pivot axis A of the pawl 153 (that is, an axis of the first pin 156 parallel to the second axis 102), the biasing force toggles the pawl 153 to select the first set of teeth 1531 or the second set of teeth 1532 to engage with the ratchet gear 154. In this example, as shown in FIG. 4, when the direction selector 157 drives the pawl 153 to be at a first position, the output shaft 13 rotates in the first direction. When the direction selector 157 drives the pawl 153 to be at a second position, the output shaft 13 moves in the second direction.

In other configurations of the ratchet wrench 1, the ratcheting mechanism 15 may alternatively include a design of double pawls. This is not to limit the substance of the present invention.

The direction of rotation of the output shaft 13 is related to the position of the pawl 153. In this example, as shown in FIG. 4, when the direction selector 157 drives the pawl 153 to be at the first position, no matter whether the electric motor 12 rotates forwardly or reversely, the first set of teeth 1531 meshes with the ratchet teeth 1541. When the ratchet gear 154 is driven by the swing member 152 to swing in the clockwise direction about the second axis 102, the ratchet gear 154 drives the anvil 155 to rotate together clockwise about the second axis 102, that is, the output shaft 13 rotates in the first direction (clockwise).

In this example, the ratchet wrench 1 includes a controller 171 for controlling the electric motor 12. Assuming that the output shaft 13 rotates in the first direction when the user makes the pawl 153 at the first position through the direction selector 157, the controller 171 is configured to control, according to a load parameter of the output shaft 13, the electric motor 12 to repeatedly change a direction of rotation of the drive shaft 121. That is to say, the load parameter of the output shaft 13 may represent a load state of the output shaft 13, and the controller 171 switches the electric motor 12 between forward rotation and reverse rotation according to the load state of the output shaft 13. In this example, during operation of the ratchet wrench 1, when an operated bolt is tightened to a certain degree, output torque of the ratchet wrench 1 cannot continue to tighten the bolt. At this time, the output shaft 13 cannot rotate, and the electric motor 12 is in a locked-rotor state. In the related art, the electric motor 12 enters locked-rotor protection and shuts down, and the bolt cannot continue to be tightened.

In the present application, when confirming, according to the load parameter of the output shaft 13, that the output shaft 13 has a large load or the electric motor 12 is in the locked-rotor state, the controller 171 sends a signal for the electric motor 12 to change the direction of rotation. In this case, the eccentric member 151 changes a direction of rotation, and the swing member 152 is driven by the eccentric member 151 to change a swing direction. For example, if the ratchet gear 154 rotates in the first direction (clockwise) and the ratchet teeth 1541 mesh with the second set of teeth 1532 of the pawl 153 in the case of a locked rotor, then the swing member 152 changes the swing direction duo to the signal from the controller 171, then the ratchet gear 154 rotates in the second direction and the ratchet teeth 1541 slide relative to the second set of teeth 1532 of the pawl 153 so that the electric motor 12 is no longer in the locked-rotor state. The electric motor 12 reverses again, and the swing member 152 performs the reciprocating swing to rotation in the first direction (clockwise) the ratchet teeth 1541 and the second set of teeth 1532 of the pawl 153 mesh with each other again, and energy is accumulated so that energy between the ratchet teeth 1541 and the pawl 153 is increased, and the output shaft 13 is driven to rotate again. This process is equivalent to one impact. The above process is repeated, and the operated bolt is more tightened. It is to be interpreted that the output torque is not increased in the present application, while it is a process in which the ratchet teeth 1541 mesh with the pawl 153 again after the reverse movement of the ratchet teeth 1541 when the locked rotation occurs, so that the energy between the ratchet teeth 1541 and the pawl 153 forms a release and accumulation process.

As shown in FIG. 10, in this example, the controller 171 is disposed on a control circuit board (not shown), where the control circuit board includes a printed circuit board (PCB) and a flexible printed circuit (FPC) board. The controller 171 adopts a dedicated control chip, for example, a single-chip microcomputer or a microcontroller unit (MCU).

The ratchet wrench 1 further includes a driver circuit 174. The driver circuit 174 is electrically connected to the stator windings U, V, and W of the electric motor 12 and configured to transmit a current from the battery pack 30 to the stator windings U, V, and W to drive the electric motor 12 to rotate. In an example, the driver circuit 174 includes multiple switching elements Q1, Q2, Q3, Q4, Q5, and Q6. A gate terminal of each switching element is electrically connected to the controller 171 and used for receiving a control signal from the controller 171. A drain or source of each switching element is connected to the stator windings U, V, and W of the electric motor 12. The switching elements Q1 to Q6 receive control signals from the controller 171 to change their respective on states, thereby changing the current loaded by the battery pack 30 to the stator windings U, V, and W of the electric motor 12. In an example, the driver circuit 174 may be a three-phase bridge driver circuit including six controllable semiconductor power devices (such as field-effect transistors (FETs), bipolar junction transistors (BJTs), or insulated-gate bipolar transistors (IGBTs)). It is to be understood that the above switching element may be any other type of solid-state switch, such as an IGBT and a BJT.

Specifically, the controller 171 controls on or off states of the switching elements in the driver circuit 174 through the control chip. In some examples, the controller 171 controls the ratio of an on time of a drive switch to an off time of the drive switch based on a pulse-width modulation (PWM) signal. It is to be noted that the control chip may be integrated into the controller 171 or may be independent of the controller 171, and the structural relationship between a driver chip and the controller 171 may be set according to an actual situation.

The ratchet wrench 1 further includes a detection mechanism 18 for detecting the load parameter of the output shaft 13. In this example, the load parameter of the output shaft 13 is compared with a first preset value, where the first preset value is set in correspondence with different load parameters for characterizing the output shaft 13.

In this example, the load parameter of the output shaft 13 is represented by a rotation parameter of the output shaft 13 or the drive shaft 121, which further represents a locked-rotor situation of the electric motor 12. The rotation parameter of the output shaft 13 or the drive shaft 121 includes at least one of a rotational speed of the output shaft 13 or the drive shaft 121, an angle of rotation of the output shaft 13 or the drive shaft 121, and rotational acceleration of the output shaft 13 or the drive shaft 121. In some examples, the detection mechanism 18 includes a first detection assembly 181. The first detection assembly 181 is used for detecting the rotation parameter of the output shaft 13 or the drive shaft 121. The first detection assembly 181 includes a position sensor, which may optionally be a photodiode sensor, a magnetic sensor, or a potentiometer. The first detection assembly 181 may also be a rotation sensor, which may optionally be a gyroscope sensor. The gyroscope sensor may be a single-axis, two-axis, or three-axis microelectromechanical systems (MEMS) sensor or a rotation-type sensor. The first preset value for a corresponding parameter is preset in the controller 171. The first preset value corresponds to a parameter value of the drive shaft 121 in a no-load or light-load state. When the rotation parameter of the drive shaft 121 is less than the first preset value, it indicates that the electric motor 12 enters the locked-rotor state.

In some examples, the load parameter of the output shaft 13 may be represented by an electrical parameter of the electric motor 12. The detection mechanism 18 includes a second detection assembly 182. The second detection assembly 182 is used for detecting at least one of a current of the electric motor 12, a freewheeling time, and a commutation parameter. The controller 171 acquires a detected value of the second detection assembly 182 and compares the detected value with the first preset value to determine the load of the output shaft 13, so as to determine whether the electric motor 12 has the locked rotor. Since the above has been fully disclosed to those skilled in the art, a detailed description is omitted here for clarity of description. Either or both of the first detection assembly 181 and the second detection assembly 182 may be disposed according to actual product requirements.

This example further discloses a control method for the ratchet wrench 1. The control method specifically includes S110 to S130.

In S110, the electric motor 12 is started.

In response to a trigger signal from the trigger switch 16, the controller 171 controls the output of the driver circuit 174 to start the electric motor 12.

In S120, the load state of the output shaft 13 is determined according to the load parameter of the output shaft 13.

In S130, in the case where it is determined that the output shaft 13 has a large load or the electric motor 12 is in the locked-rotor state, the motor 12 is controlled to periodically change the direction of rotation of the drive shaft 121.

To increase use conditions of the ratchet wrench 1 and satisfy use habits of different users, in this example, the ratchet tool includes a selectable first mode and a selectable second mode. When the ratchet tool is in the first mode, the controller 171 is configured to control, according to the load parameter of the output shaft 13, the electric motor 12 to repeatedly change the direction of rotation of the drive shaft 121. When the ratchet tool is in the second mode, the controller 171 is configured to control the electric motor 12 to drive the drive shaft 121 to rotate in a set direction. That is to say, in addition to the first mode described above, the ratchet wrench 1 still retains a conventional mode in the related art where the user actively selects the forward rotation or the reverse rotation of the electric motor.

As shown in FIGS. 1 to 2 and FIGS. 5 to 11, the ratchet tool includes a human-machine interaction assembly 19 for ease of setting and operation of the user. The human-machine interaction assembly 19 is coupled to the controller 171 and inputs a signal to the controller 171. In this example, the human-machine interaction assembly 19 includes an operating element 191 and a second controller 192. The second controller 192 is coupled to the controller 171. In this example, the second controller 192 is disposed on a second control circuit board 172. The second control circuit board 172 includes a printed circuit board (PCB) and a flexible printed circuit (FPC) board. The second controller 192 adopts a dedicated control chip, for example, a single-chip microcomputer or a microcontroller unit (MCU). It is to be understood that the controller 171 is used for controlling the electric motor 12 and is a main controller of the ratchet wrench 1. The second controller 192 is used for controlling the human-machine interaction assembly 19 and coupled to the operating element 191.

The operating element 191 includes a display portion 1911 and an input portion 1912. The display portion 1911 is used for providing the user with feedback, that is, an information prompt. The display portion 1911 may be, for example, a state indicator light, an audio prompt, a liquid crystal display (LCD), a light-emitting diode (LED) display, an organic light-emitting diode (OLED) display, or an organic electroluminescent (EL) display. The input portion 1912 may be a button, a keypad, a knob/toggle button, touch input, or the like. In some examples, the display portion 1911 is configured to be a touchpad so that the display portion 1911 and the input portion 1912 are integrated. In other alternative examples, the input portion 1912 may be replaced with an external device, such as a smartphone, a tablet computer, a laptop, or the like.

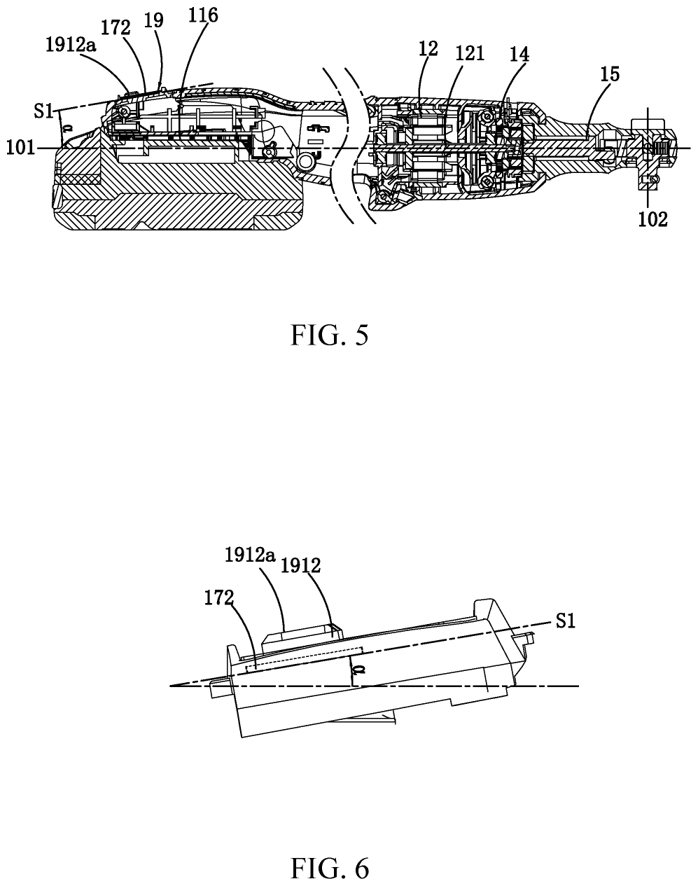

As shown in FIGS. 5 to 7, the second control circuit board 172 extends within a first plane S1. The second control circuit board 172 obliquely intersects the first axis 101. It is to be understood that when the second control circuit board 172 is a plate-like structure such as the PCB, the second control circuit board 172 extends as a whole within the first plane S1. When the second control circuit board 172 is the FPC board, the FPC board extends as a whole within the first plane S1 after being installed on the ratchet wrench 1. In this example, the angle a between the first axis 101 and the first plane S1 is less than or equal to 45°. In this example, the angle a between the first axis 101 and the first plane S1 is less than or equal to 30°.

In this example, the second control circuit board 172 at least partially overlaps the battery pack 30 along the first axis 101, that is, in a front and rear direction. Optionally, at least a third straight line extending along an up and down direction passes through both the second control circuit board 172 and the battery pack 30. The input portion 1912 of the human-machine interaction assembly 19 includes a contact surface 1912a in contact with a finger or a hand of the user. The contact surface 1912a is parallel to the first plane S1. The operating element 191 is disposed on a second side surface S2 of the power supply connecting portion 115. The second side surface S2 is located at the rear end of the coupling portion 116 or on a side of the power supply connecting portion 115 facing away from the coupling portion 116. In this example, the coupling portion 116 is disposed on a side facing a working surface, that is, a lower side, and the second side surface is located on an upper side. In some alternative examples, the second side surface may be located on the rear side of the coupling portion 116, that is, the rear side of the ratchet wrench 1, which is more in conformity with human-machine operation habits.

As shown in FIG. 8, as an alternative example of an arrangement manner of an operating element 191′, the trigger switch 16 is disposed below the grip 113. The operating element 191′ is disposed on the upper side or the lower side of the motor housing 112. During operation of the user, it is convenient for the user to see display on a human-machine interaction assembly 19′.

As shown in FIG. 11, the rotational speed of the electric motor 12 is adjusted according to a trigger stroke of the trigger switch 16. In this example, the trigger switch is coupled to a sliding rheostat, and the sliding rheostat outputs different analog signals according to different trigger strokes of the trigger switch. The trigger stroke of the trigger switch is positively correlated to a duty cycle of a PWM signal of the electric motor 12, and the duty cycle of the PWM signal is positively correlated to the rotational speed of the electric motor 12. When the trigger stroke of the trigger switch is relatively small, the duty cycle of the PWM signal is relatively low, and the rotational speed of the electric motor 12 is also relatively low.

In some examples, a mapping relationship between the trigger stroke of the trigger switch and the PWM signal is stored in the ratchet wrench 1, where the mapping relationship may be linear or non-linear, which is not limited in the examples of the present application.

In this example, the ratchet wrench 1 includes a speed adjustment assembly. The speed adjustment assembly is used for controlling a rotational speed of the output shaft 13 or a range of rotational speeds of the output shaft 13 corresponding to a maximum trigger stroke of the trigger switch.

As an example, the speed adjustment assembly is mechanically coupled to the transmission mechanism 14 to adjust a gear ratio of the transmission mechanism 14. For convenience of reference, the speed adjustment assembly using a mechanical manner is defined as a first adjustment assembly 21.

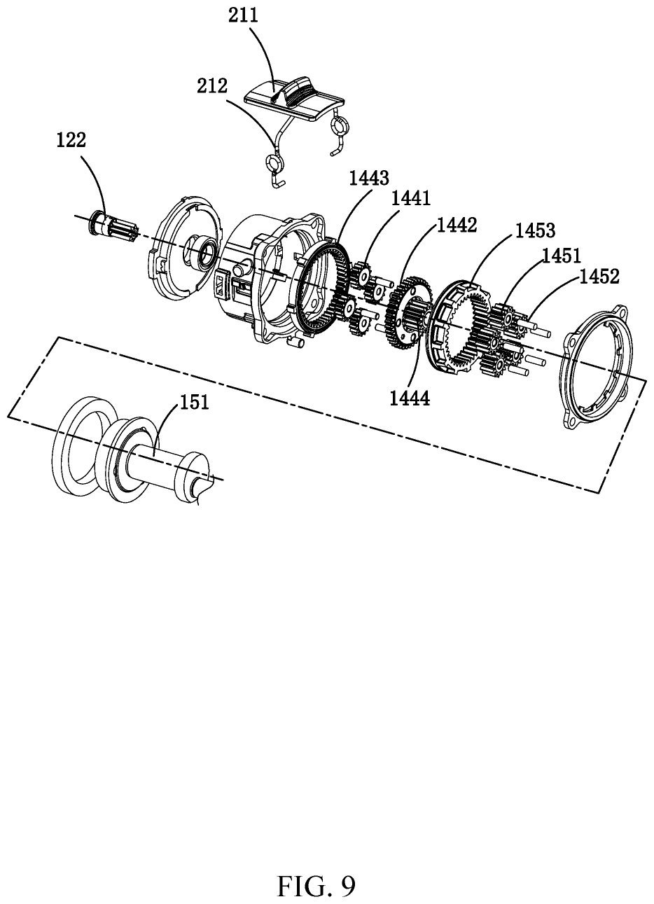

As shown in FIGS. 5 and 9, the transmission mechanism 14 includes a multi-stage transmission set. In this example, the multi-stage transmission set is a multi-stage planetary transmission set. The planetary transmission set includes planet gears, a planet carrier for mounting the planet gears, and an inner ring gear meshing with the planet gears. At least one stage of planetary transmission set in the multi-stage planetary transmission set is configured with an adjustable gear ratio. A planet carrier in a planetary transmission set closer to the ratcheting mechanism 15 in the multi-stage planetary transmission set is formed on or connected to the eccentric member 151. In this example, an inner ring gear in at least one stage of planetary transmission set is configured to move between a first position and a second position to switch the gear ratio of the transmission mechanism 14. It is to be understood that in this example, to ensure the overall length of the ratchet wrench 1 as much as possible, two transmission states and two stages of planetary gearsets are provided. However, according to the actual product requirements, the transmission mechanism 14 may be provided with more than two transmission states and more than two stages of planetary gearsets. The above does not affect the substance of the present application.

The transmission mechanism 14 includes a first-stage planetary gearset 144 and a second-stage planetary gearset 145, where the first-stage planetary gearset 144 includes first planet gears 1441, a first planet carrier 1442 for mounting the first planet gears 1441, and a first inner ring gear 1443 meshing with the first planet gears 1441. The drive shaft 121 is formed on or connected to a first sun gear 122 rotating at a first rotational speed.

The second-stage planetary gearset 145 includes second planet gears 1451, a second planet carrier 1452 for mounting the second planet gears 1451, and a second inner ring gear 1453 meshing with the second planet gears 1451. A second sun gear 1444 drives the second planet gears 1451. The second sun gear 1444 rotates coaxially with the drive shaft 121. The second planet carrier 1452 is formed at the rear end of the eccentric member 151. The second planet gears 1451 drive, through the second planet carrier 1452, the eccentric member 151 to rotate. In other alternative examples, the second planet carrier 1452 and the eccentric member 151 may be independent components, and the second planet carrier 1452 is connected to the eccentric member 151, as long as the second planet gears 1451 can drive the eccentric member 151 to rotate. The first adjustment assembly 21 is used for driving the transmission mechanism 14 to switch between different transmission states. The first adjustment assembly 21 includes a toggle button 211 for the user to operate and a shift bracket 212. The toggle button 211 drives the shift bracket 212 to displace.

In this example, the first-stage planetary gearset 144 has a gear ratio of 1 which is not adjustable, and the second-stage planetary gearset 145 has two gear ratios. A second gear ratio is substantially equal to 1, that is to say, the second-stage planetary gearset 145 performs only transmission. The second-stage planetary gearset 145 is in a second transmission state. A third gear ratio is greater than 1, that is to say, reduction transmission is performed. The second-stage planetary gearset 145 is in a second variable state. The shift bracket 212 is connected to the second inner ring gear 1453 to drive the second inner ring gear 1453 to displace, so as to switch a transmission state of the second-stage planetary gearset 145. In some alternative examples, the first-stage planetary gearset 144 may have two gear ratios. The working principles of planetary gear reduction and mechanical adjustment of the gear ratio and the reduction performed by the transmission mechanism 14 have been fully disclosed to those skilled in the art. Therefore, a detailed description is omitted here for clarity of description.

As another example, a current, voltage, and duty cycle in the driver circuit 174 of the electric motor 12 may be adjusted, and electrical parameters such as a phase angle (conduction angle) of the electric motor, a lead angle of the electric motor, and output power of the electric motor may be adjusted so that a maximum output rotational speed of the electric motor 12 is controlled. The maximum output rotational speed of the electric motor 12 is changed so that a maximum output speed of the output shaft 13 is adjusted, that is, in an electronic manner. For convenience of reference, the speed adjustment assembly using the electronic manner is defined as a second adjustment assembly 22.

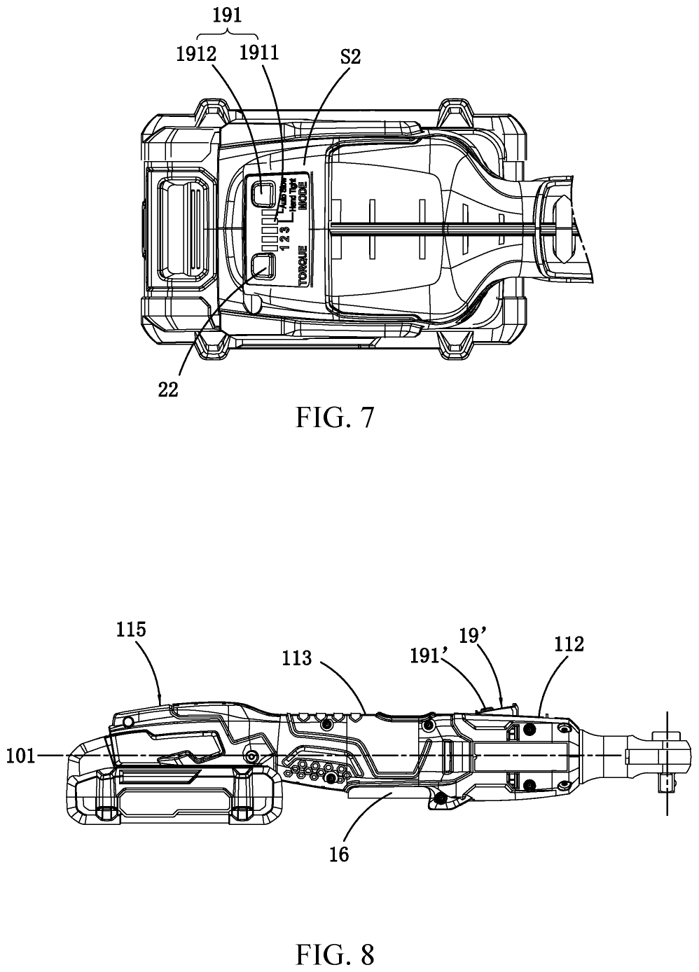

As shown in FIG. 11, in the example of adjustment in the electronic manner, the controller 171 is configured to adjust, according to a setting of the human-machine interaction assembly 19, the output rotational speed or a range of output rotational speeds of the electric motor 12 when the trigger switch 16 has the maximum trigger stroke. In this example, as shown in FIG. 7, the second adjustment assembly 22 is disposed on the human-machine interaction assembly 19. Optionally, the controller 171 controls, according to received input information, the output rotational speed or the range of output rotational speeds of the electric motor 12 when the trigger switch 16 has the maximum trigger stroke. In this example, the input information received by the controller is from an operation performed by the user on the human-machine interaction assembly 19. In other alternative examples, the input information received by the controller 171 may be from recognition of another sensor or an output signal based on machine learning.

As described above, the human-machine interaction assembly 19 includes the second controller 192. In this example, the second controller 192 is configured to convert an instruction received by the operating element 191 into corresponding input information and send a signal of the corresponding input information to the controller 171.

To facilitate the operation and use of the user, the second controller 192 presets parameters of at least two gear modes, and the operating element 191 is operated to select one gear mode. Each gear mode corresponds to a parameter of one output rotational speed or one range of output rotational speeds of the electric motor 12 when the trigger switch 16 has the maximum trigger stroke. Meanwhile, the controller 171 controls, according to a signal of a parameter outputted from the second controller 192, the output rotational speed of the electric motor 12 when the trigger switch 16 has the maximum trigger stroke.

Optionally, the second adjustment assembly 22 is configured to adjust gear information for characterizing the output rotational speed of the electric motor 12. The second controller 192 corresponds information from the operating element 191 to a set input parameter and sends a signal of the input parameter to the controller 171. The controller 171 sends the signal of the input parameter to the electric motor to control the electric motor 12 to rotate. In other alternative examples, characterization by actual values or by gears may be implemented. The above does not affect the substance of the present application.

In some examples, the human-machine interaction assembly 19 is configured for the user to select a different torque gear as the input parameter. In some examples, the human-machine interaction assembly 19 is configured for the user to select a different rotational speed gear as the input parameter. In some examples, the human-machine interaction assembly 19 is configured for the user to select a gear representing any one of the rotational speed or the torque as the input parameter, for example, “high”, “medium”, and “low” or “1”, “2”, and “3”.

Optionally, different gears may correspond to different maximum output rotational speeds of the electric motor 12. Optionally, different maximum output rotational speeds of the electric motor 12 correspond to different output torque applied by the output shaft to a fastener. Optionally, for each gear, the electric motor 12 operates within a range of rotational speed values. Ranges of output rotational speeds of the electric motor 12 for different gears may partially overlap. In some examples, the ranges of output rotational speeds of the electric motor 12 for different gears may not overlap. In some examples, the ranges of output rotational speeds of the electric motor 12 for different gears are a continuous value range of, for example, greater than or equal to 0 and less than or equal to 2000 revolutions per minute (rpm). In some examples, the ranges of output rotational speeds of the electric motor 12 for different gears may be sets of discrete values, for example, 0, 500 rpm, and 1000 rpm form a set corresponding to one gear.

In the related art, the output shaft 13 of the ratchet tool has an average rotational speed of 250 rpm to 400 rpm. For such a relatively small output rotational speed, when the rotational speed of the electric motor is controlled by the trigger stroke of the trigger switch, the user can accurately obtain a desired speed and maintain the speed by maintaining a pressing force. When the rotational speed of the output shaft 13 is increased to 800 rpm or even 1000 rpm, if the rotational speed of the electric motor 12 is controlled only by the trigger stroke of the trigger switch 16, an appropriate rotational speed is not easy to obtain, and the rotational speed is easy to suddenly increase, causing a damage to a workpiece. Selectable gears are disposed so that the rotational speed of the electric motor 12 is limited within a range and then adjusted and controlled within the range by the trigger stroke of the trigger switch 16. In this manner, the user can be guaranteed to more easily obtain a required rotational speed and then obtain required torque. For the ratchet tool provided with a high output rotational speed, selectable different rotational speed gears are disposed so that the sense of operation of the user can be improved, and the safety and stability of use of the product can be ensured.

However, according to the actual product requirements, in product applications, either mechanical adjustment or electronic adjustment of the present application may be used alone, or both electronic speed regulation and mechanical speed regulation may be used. The diverse adjustment manners provide more adjustment options.

In this example, the human-machine interaction assembly 19 may also be used as a state indicator to feed back a working state of the ratchet wrench 1 in real time or used as an abnormal state alarm module to prompt an abnormality by a buzzer or a color or a change of a flicker state of a state light. It is to be understood that the human-machine interaction assembly 19 has different specific functions in different products according to different control programs.

In this example, the grip 113 has a tubular structure overmolded, and the diameter of the grip 113 is less than or equal to that of the motor housing 112 or the power supply connecting portion 115. In this example, the grip 113 is formed of an elastic material (such as rubber or silicone).

In this example, the head housing 114 is made of nitro-carburized steel and disposed near the motor housing 112. Steel is suitable for reducing flux losses in the motor 12. In other structures, other metals suitable for reducing the flux losses, such as other ferromagnetic materials, may be used.

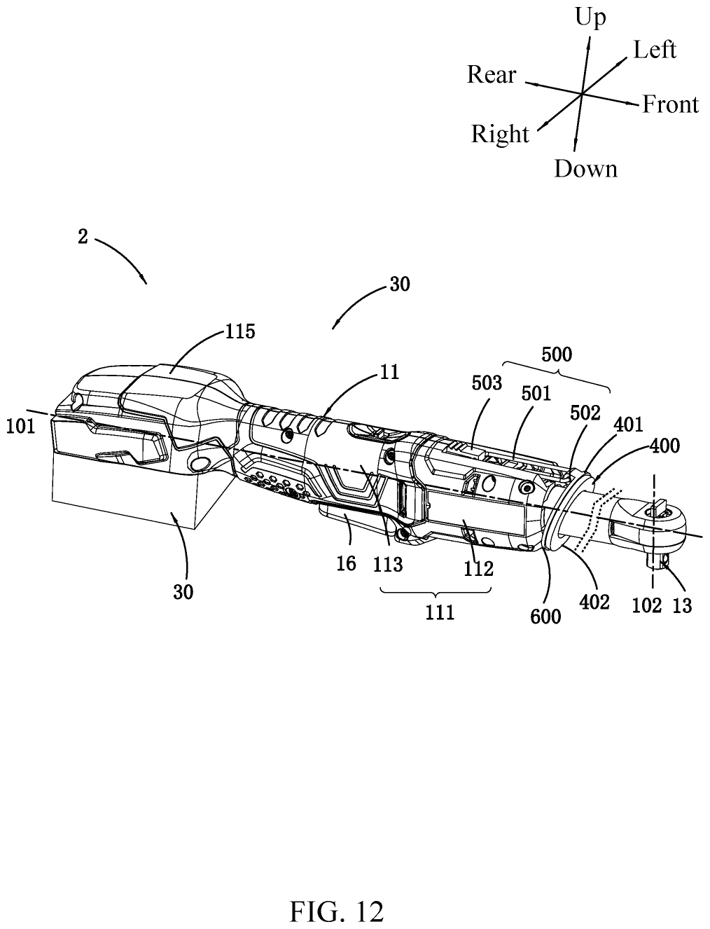

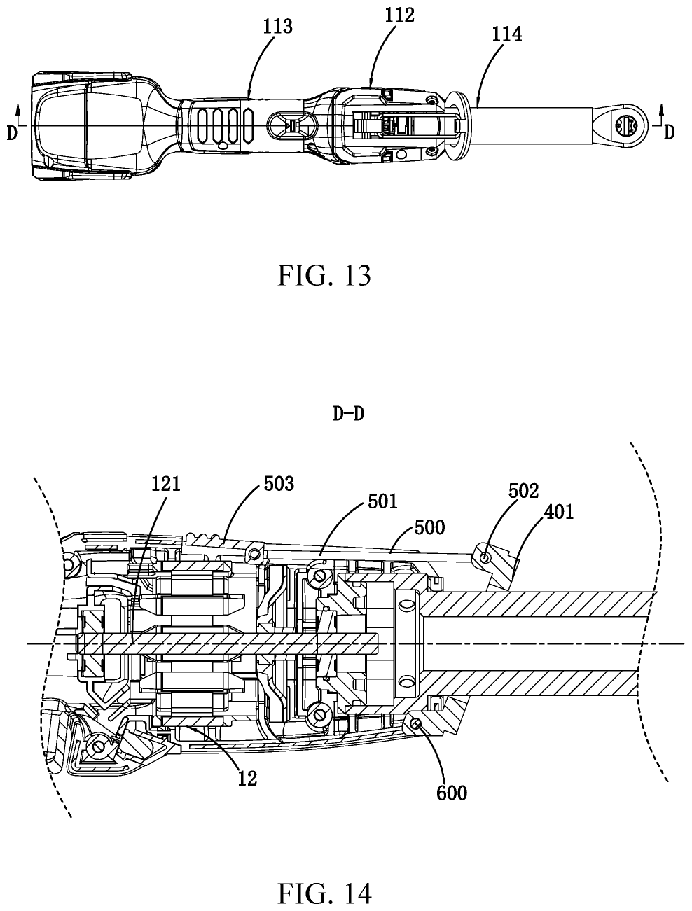

FIGS. 12 to 16 show another example of the present application. In this example, a ratchet wrench 2 is provided with a lighting mechanism 400. The lighting mechanism 400 may be used with the ratchet wrench 1 in FIG. 1. Therefore, components of the ratchet wrench 2 having the same functions as those of the ratchet wrench 1 may directly use the reference numerals.

In this example, the lighting mechanism 400 is disposed between the main housing 111 and the output shaft 13 and used for illuminating a working region. The lighting mechanism 400 is configured to adjust a position of the lighting mechanism 400 relative to the main housing 111 or the output shaft 13 according to a direction set through an operation. The position of the lighting mechanism 400 may be adjusted according to an external environment, a working requirement, and the like. The position of the lighting mechanism 400 relative to the main housing 111 or the output shaft 13 is changed so that an irradiation range is increased, and a lighting effect is improved, thereby facilitating operation. Thus, the following problem in the related art is solved: a lighting lamp has a fixed position and can only illuminate a poor field of view, resulting in a failure to clearly see a workpiece in a narrow space under a special working condition or a harsh working condition.

In an example, as shown in FIGS. 12 and 14, the ratchet wrench 2 further includes a first spindle 600 perpendicular to the drive shaft 121. The first spindle 600 is disposed eccentrically with respect to a central axis of the lighting mechanism 400. In this example, a lighting element 402 of the lighting mechanism 400 can swing about the first spindle 600. Optionally, the lighting element 402 can reciprocatingly swing forward and backward about the first spindle 600. In some alternative examples, according to a different position of the first spindle 600, the lighting element 402 can reciprocatingly swing left and right about the first spindle 600. Since the first spindle 600 is disposed eccentrically, during the swing, the lighting mechanism 400 has a displacement and a change of an irradiation angle relative to the main housing 111 or the output shaft 13, thereby changing the irradiation range.

As shown in FIGS. 12 and 14, the ratchet wrench 2 further includes an operating assembly 500 connected to the lighting mechanism 400. The operating assembly 500 is disposed on the housing 11 and can move along a direction (for example, a direction parallel to the drive axis or the first axis 101) to drive the lighting mechanism 400 to awing about the first spindle 600. The operating assembly 500 facilitates an operation on the lighting mechanism. During use of the ratchet wrench 2, the operating assembly 500 is driven along the direction parallel to the drive axis or the first axis 101 to swing the lighting mechanism. Optionally, the operating assembly 500 includes a connecting rod 501. The connecting rod 501 is a rigid member. A second spindle 502 and an operating member 503 are provided at two ends of the connecting rod 501. The operating member 503 is connected to the housing 11. The lighting mechanism 400 is rotatably connected to the second spindle 502. Optionally, the second spindle 502 and the first spindle 600 are disposed on two sides of the central axis of the lighting mechanism, separately. The user pushes and pulls the connecting rod 501 so that the lighting mechanism 400 can swing about the first spindle 600. When the position of the lighting mechanism 400 does not need to be adjusted or is adjusted in place, the operating member 503 is limited onto the housing 11 to prevent the lighting mechanism 400 from shaking and affecting use during operation of the ratchet wrench 2. In other examples, the operating assembly 500 may also include a flexible member such as a draw cord, which is not limited.

As shown in FIGS. 12 to 15, the housing 11 includes the head housing 114 for accommodating at least part of the output shaft 13. The lighting mechanism 400 includes a mounting frame 401 for mounting the lighting element 402. The mounting frame 401 is ring-shaped and sleeved on the head housing 114, and the mounting frame 401 is connected to the operating assembly 500 and the first spindle 600 to ensure that the lighting element 402 is always displaced along a direction of a centerline of the head housing 114 and does not deviate. In an example, the mounting frame 401 is in the shape of a circular ring and has two opposite ends connected to the operating assembly 500 and the first spindle 600 so that the distance between the operating assembly 500 and the first spindle 600 is increased, so as to increase the displacement and range of adjustable angles of the lighting mechanism 400.

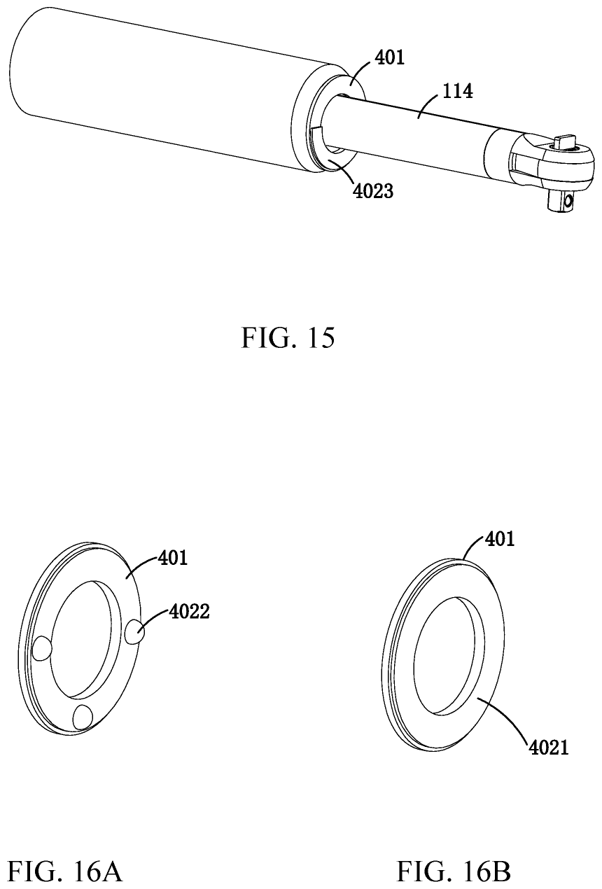

In the related art, the lighting lamp of the ratchet wrench 2 is a single lamp, and since the output shaft 13 and an extended axis of the housing of the tool such as the ratchet wrench are arranged at an angle, irradiating light of the single lamp is easily shielded, and a shadow is easily caused. In an example, as shown in FIGS. 15, 16A, and 16B, the lighting element 402 is an annular lamp 4021, multiple spaced beads 4022, or a semi-annular lamp 4023. Multiple beads or the annular lamp 4021 is used to provide a shadowless effect and a better human-machine effect.

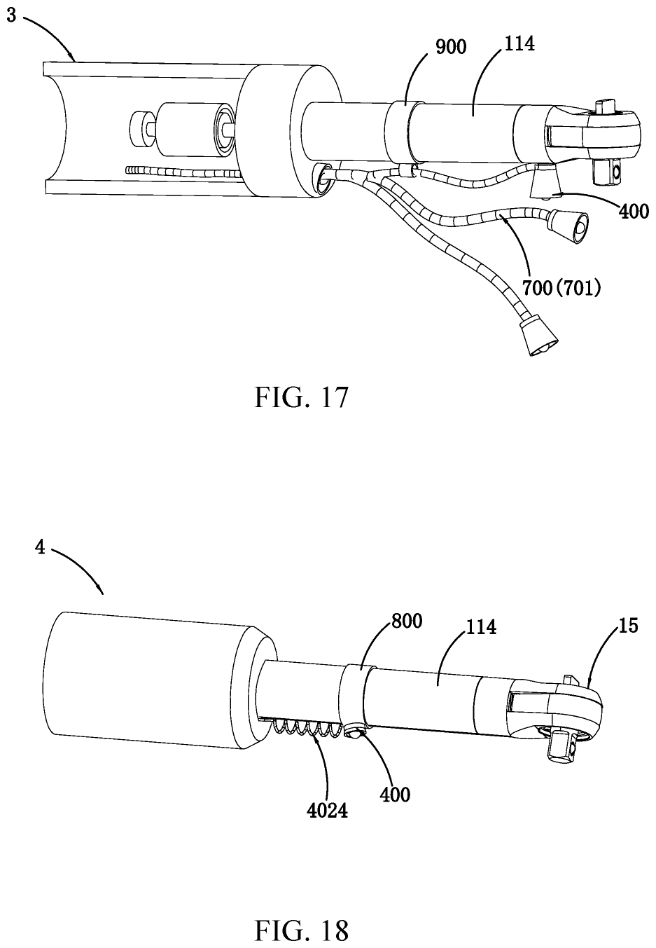

As shown in FIG. 17, this example further provides a ratchet wrench 3, which is substantially the same as the structure in example one, and the same content is not repeated here. As shown in FIG. 17, this example differs from the ratchet wrench 2 in that the ratchet wrench 3 further includes a flexible member 700. The lighting mechanism 400 is connected to the housing 11 through the flexible member 700. The position of the lighting mechanism 400 may be adjusted through the flexible member 700. In this example, the flexible member 700 is a flexible tube 701. The flexible tube 701 is bent so that the position of the lighting mechanism 400 changes, so as to change an angle and a displacement of the lighting mechanism 400 relative to the main housing 111 or the output shaft 13. The flexible member 700 adopts a flexible shaft which has an effect of infinite adjustment and can be arbitrarily shaped so that the lighting mechanism 400 is adjusted to any position. A cable is provided inside the flexible member 700 and the housing 11 to connect the lighting mechanism 400 to the direct current power supply 30 so that the lighting mechanism 400 is supplied with power, and the cable is prevented from being exposed and has good appearance.

In an example, the housing 11 includes the head housing 114 for accommodating at least part of the output shaft 13, and the lighting mechanism 400 includes an adsorption member that can be adsorbed to the head housing 114. In an example, the adsorption member is a magnet that can be arbitrarily adsorbed to the head housing 114, thereby avoiding the case where the lighting mechanism 400 changes in position with the flexible tube 701 due to external interference in a working process after the position of the lighting mechanism 400 is adjusted, affecting working progress.

In an example, the lighting mechanism 400 is connected to an end of the flexible member 700. An end of the flexible member 700 facing away from the lighting mechanism 400 is configured to move away from and towards the main housing 111. The flexible member 700 can pull the lighting mechanism 400 back and fix the lighting mechanism 400 to the main housing 111. During use, the flexible member 700 is pulled so as to adjust the position of the lighting mechanism 400 so that the lighting mechanism 400 is bent relative to the flexible member 700 to adjust the angle. When the lighting mechanism 400 is not used, the lighting mechanism 400 may be pulled back and fixed to the main housing 111 through the flexible member 700 so that the lighting mechanism 400 not in need is prevented from interfering with operation and is convenient to store. In an example, the main housing 111 is provided with a clamping portion, and the lighting mechanism can be clamped on the clamping portion. In an example, a fixing ring 900 is further sleeved on the head housing 114 and provided with a threading hole. The flexible tube 701 may penetrate through the threading hole so that the flexible tube 701 is bound to the head housing 114, thereby improving aesthetic appearance and preventing the flexible tube 701 from drooping and affecting a line of sight.

As shown in FIG. 18, this example further provides a ratchet wrench 4, which has substantially the same structure as the ratchet wrench 2 and the ratchet wrench 3, and the same content is not repeated here. As shown in FIG. 18, this example differs from the ratchet wrench 2 in that the housing 11 includes the head housing 114 for accommodating at least part of the output shaft 13, the ratchet wrench 4 further includes a sliding sleeve 800, the lighting mechanism 400 is connected to the sliding sleeve 800, and the sliding sleeve 800 is slidably connected to the head housing 114. A position of the sliding sleeve 800 relative to the main housing 111 or the output shaft 13 is adjusted so that the position of the lighting mechanism 400 is adjusted. During use, after the position of the sliding sleeve 800 is adjusted, the sliding sleeve 800 may be fixed to the head housing 114 by a jackscrew, so as to prevent the lighting mechanism 400 from changing arbitrarily during operation. After the jackscrew is released, the sliding sleeve 800 and the lighting mechanism 400 thereon may be adjusted again.

In an example, the lighting mechanism 400 further includes a spring rope 4024, where an end of the spring rope 4024 is connected to the lighting lamp, and the other end of the spring rope 4024 extends into the housing 11 to be connected to the direct current power supply 30, so as to supply power to the lighting lamp. The spring rope 4024 has two functions: in one aspect, a wire is configured to be the stretchable and retractable spring rope 4024, and the sliding sleeve 800 is reset directly by use of a spring property of the spring rope 4024; in the other aspect, when a hydraulic device or a telescopic rod structure is provided to reset the sliding sleeve 800, the spring rope 4024, as the wire, is placed inside the hydraulic device or the telescopic rod structure.

In an example, the lighting mechanism 400 may be a patch lamp to reduce a radial dimension of the lighting mechanism 400 along the head housing 114. In an example, the sliding sleeve 800 may be rotatably connected to the head housing 114 to adjust the angle of the lighting mechanism 400.

This example provides an angle power tool including a housing 11, an electric motor 12, an output shaft 13, and a lighting mechanism 400, where the housing 11 includes a main housing 111 extending substantially along a direction of a first axis 101; the electric motor 12 includes a drive shaft 121 rotating to output torque and is at least partially accommodated in the main housing 111; the output shaft 13 is used for outputting power, is at least partially disposed outside the housing 11, and rotates about an output axis, where the output axis intersects the first axis 101; and the lighting mechanism 400 is disposed between the main housing 111 and the output shaft 13 and used for illuminating a working region. The lighting mechanism 400 is configured to adjust a position of the lighting mechanism 400 relative to the main housing 111 or the output shaft 13 according to a direction set through an operation.

The lighting mechanism 400 is disposed between the main housing 111 and the output shaft 13 and used for illuminating the working region. The position of the lighting mechanism 400 may be adjusted according to a working requirement such as an external environment. The position of the lighting mechanism 400 relative to the main housing 111 or the output shaft 13 is changed so that an irradiation range is increased, and a lighting effect is improved, thereby facilitating operation. Thus, the following problem in the existing art is solved: a lighting lamp has a fixed position and can only illuminate a poor field of view, resulting in a failure to clearly see a workpiece in a narrow space under a special working condition or a harsh working condition. The angle power tool may be an angular tool such as an angle drill and an angle grinder, which is not limited.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A ratchet tool, comprising:
a housing formed with or connected to a grip;
a motor comprising a drive shaft rotating about a first axis;
a ratcheting mechanism driven by the drive shaft, wherein the ratcheting mechanism comprises an output shaft rotating about an output axis and a pawl, a direction of rotation of the output shaft is controlled by a position of the pawl, the output shaft rotates in a first direction when the pawl is at a first position, and the output shaft moves in a second direction when the pawl is at a second position;
a trigger switch, wherein the motor corresponds to different output rotational speeds according to different trigger strokes of the trigger switch;
a human-machine interaction assembly configured to be operated and output information; and
a controller for controlling the motor;
wherein the human-machine interaction assembly is coupled to the controller, the controller is configured to adjust, according to a setting of the human-machine interaction assembly, an output rotational speed or a range of output rotational speeds of the motor when the trigger switch has a maximum trigger stroke.

2. The ratchet tool of claim 1, wherein the human-machine interaction assembly comprises an operating element and a second controller, and the second controller is coupled to the controller.

3. The ratchet tool of claim 2, wherein the second controller presets parameters of at least two gear modes, the operating element is operated to select one of the at least two gear modes, and each of the at least two gear modes corresponds to a parameter of one output rotational speed or one range of output rotational speeds of the motor when the trigger switch has the maximum trigger stroke.

4. The ratchet tool of claim 3, wherein the controller controls, according to a signal of a parameter outputted from the second controller, the output rotational speed of the motor when the trigger switch has the maximum trigger stroke.

5. The ratchet tool of claim 1, wherein the human-machine interaction assembly is further configured to switch a mode of the ratchet tool to a first mode or a second mode.

6. The ratchet tool of claim 5, wherein, when the ratchet tool is in the first mode, the controller is configured to control, according to a load parameter of the output shaft, the motor to repeatedly change a direction of rotation of the drive shaft.

7. The ratchet tool of claim 6, further comprising a detection mechanism for detecting the load parameter of the output shaft, wherein the load parameter of the output shaft comprises at least one of a rotational speed-related parameter of the motor and a current-related parameter of the motor.

8. The ratchet tool of claim 6, further comprising a detection mechanism for detecting the load parameter of the output shaft, wherein the load parameter of the output shaft comprises at least one of a rotational speed of the output shaft, an angle of rotation of the output shaft, and rotational acceleration of the output shaft.

9. The ratchet tool of claim 6, wherein, when the ratchet tool is in the second mode, the controller is configured to control the drive shaft of the motor to rotate in a set direction.

10. The ratchet tool of claim 1, wherein the human-machine interaction assembly comprises a control circuit board extending within a first plane, the housing extends substantially along a direction of the first axis, and the control circuit board obliquely intersects the first axis.

11. The ratchet tool of claim 10, wherein an angle between the first axis and the first plane is less than or equal to 45°.

12. The ratchet tool of claim 10, wherein the human-machine interaction assembly is disposed in front of or behind the grip.

13. A ratchet tool, comprising:
a housing formed with or connected to a grip for holding;
a motor comprising a drive shaft rotating about a first axis;
a ratcheting mechanism driven by the drive shaft, wherein the ratcheting mechanism comprises an output shaft rotating about an output axis and a pawl, a direction of rotation of the output shaft is controlled by a position of the pawl, the output shaft rotates in a first direction when the pawl is at a first position, and the output shaft moves in a second direction when the pawl is at a second position;
a controller for controlling the motor; and
a human-machine interaction assembly coupled to the controller;
wherein the controller controls an output state of the motor according to a load parameter of the output shaft when the ratchet tool is in a first mode, the controller controls the output state of the motor according to input information of the human-machine interaction assembly when the ratchet tool is in a second mode, and the human-machine interaction assembly is configured to switch a mode of the ratchet tool and/or set the input information.

14. A ratchet tool, comprising:
a housing formed with or connected to a grip for holding;
a motor comprising a drive shaft rotating about a first axis;
a ratcheting mechanism driven by the drive shaft, wherein the ratcheting mechanism comprises an output shaft rotating about an output axis and a pawl, a direction of rotation of the output shaft is controlled by a position of the pawl, the output shaft rotates in a first direction when the pawl is at a first position, and the output shaft moves in a second direction when the pawl is at a second position;
a trigger switch, wherein the motor corresponds to different output rotational speeds according to different trigger strokes of the trigger switch; and
a speed adjustment assembly configured to adjust an output rotational speed of the output shaft when the trigger switch has a maximum trigger stroke.

15. The ratchet tool of claim 14, further comprising a controller configured to control, according to received input information, an output rotational speed of the motor when the trigger switch has the maximum trigger stroke.

16. The ratchet tool of claim 15, further comprising a human-machine interaction assembly coupled to the controller and configured to be operated to set input information.

17. The ratchet tool of claim 16, wherein the human-machine interaction assembly comprises an operating element and a second controller, and the second controller is coupled to the controller.

18. The ratchet tool of claim 17, wherein the second controller is configured to convert an instruction received by the operating element into corresponding input information and send a signal of the corresponding input information to the controller.

19. The ratchet tool of claim 17, wherein the second controller presets at least two gear modes, and the operating element is operated to select one of the at least two gear modes, and each of the at least two gear modes is configured with respective input information.

20. The ratchet tool of claim 14, further comprising a transmission assembly for connecting the motor to the ratcheting mechanism, wherein the speed adjustment assembly is mechanically coupled to the transmission assembly to adjust a gear ratio of the transmission assembly.
